(19) United States
(12) Patent Application Publication
(10) Pub. No.: US 2015/0039503 A1
(43) Pub. Date: Feb. 5, 2015

(54) MOBILE REMITTANCES/PAYMENTS

(71) Applicant: eBay Inc., San Jose, CA (US)

(72) Inventor: Vishwanath Shastry, Mountain View, CA (US)

(73) Assignee: eBay Inc., San Jose, CA (US)

(21) Appl. No.: 13/959,586

(22) Filed: Aug. 5, 2013

(51) Int. Cl. G06Q 20/32

(52) U.S. Cl. CPC G06Q 20/3223
USPC 705/42

(57) ABSTRACT

A method and a system for mobile remittance and/or payment are provided. Example embodiments may include receiving a request, at a financial entity and from a first party, to remit an amount from an account, associated with the first party to a mobile phone number associated with a second party; notifying the second party of the amount to be remitted and an identity of the first party; receiving a personal identification component from the second party; accessing a mobile account associated with the mobile phone number based on the personal identification component; and depositing the amount into the mobile account. According to example embodiments, the system may include a communication module, a mobile remittance module, a payment processor, a mobile accounts module, an agent management module, and a mobile transfer module.

### CLAIM OF PRIORITY

This application is a continuation application of U.S. Ser. No. 11/848,745 filed on Aug. 31, 2007, the entire content of each application being incorporated herein by reference.

### TECHNICAL FIELD

Example embodiments relate generally to the technical field of mobile communication, and in one specific example, to a system for mobile remittances and/or payments.

### BACKGROUND

Worldwide spread of mobile communication has changed the landscape of communication and affected numerous aspects of life, including commerce and entertainment. Due to their rapid deployment and low establishment cost, mobile communication networks have spread rapidly throughout the world, outstripping the growth of land lines. In many third world countries mobile phones are becoming available to more and more of less privileged groups of people who may lack access to personal fixed phones.

Today's mobile phones, in addition to the standard phone function, can support many additional services such as SMS (Short Message Service) for text messaging, email, packet switching for access to the Internet, and MMS (Multimedia Messaging Service) for communicating images and video data. Text messaging is now the most widely used mobile data service on the planet and has found applications far more than just inter-personal communication.

### BRIEF DESCRIPTION OF THE DRAWINGS

Some embodiments are illustrated by way of example and not limitation in the figures of the accompanying drawings in which:

FIG. 1 is a high level diagram depicting an example embodiment of a method for mobile remittances and/or payments;

FIG. 2 is a high level diagram illustrating example embodiments of various spending channels available to a mobile account holder;

FIG. 3 is a block diagram illustrating an example embodiment of a system for mobile remittances and/or payments;

FIG. 4 is a block diagram depicting an example embodiment of a sub-module configuration of a mobile transfer module

FIG. 5 is a diagram illustrating in an example embodiment various components of an agent.

FIG. 6 is an example flow diagram illustrating a method for mobile remittances and/or payments;

FIG. 7 is high level block diagram illustrating an example embodiment of a network-based mobile remittance system, having a client-server architecture, facilitating mobile remittances and/or payments.

FIG. 8 is an example set of financial and educational applications used by the network-based financial system of FIG. 7; and

FIG. 9 is a block diagram illustrating a diagrammatic representation of a machine in the example form of a computer system.

### DETAILED DESCRIPTION

Example methods and systems for mobile remittances an/or payments have been described. In the following description, for purposes of explanation, numerous specific details are set forth in order to provide a thorough understanding of example embodiments. It will be evident, however, to one skilled in the art that the present invention may be practiced without these specific details.

For the purpose of present application, the term “agent” shall be taken to include, but not be limited to, a person or a machine (e.g. Automated Teller Machine (ATM)) that is capable of taking some kind of identification (e.g., driver license, passport, other valid identification cards, or biometric identification) to verify the identity of a customer.

For the purpose of present application, the term “mobile account” shall be taken to include, but not be limited to, an account associated with a mobile phone number. A mobile account may be distinguished from a normal account in many aspects including the way the account is opened, held and redeemed from.

For the purpose of present application, the term “normal account” shall be taken to include, but not be limited to, any account other than a mobile account.

Some embodiments described herein may include providing for a user to remit some amount from his/her account in a financial entity (e.g., PayPal, a subsidiary of eBay, San Jose, Calif.) to one or more mobile phone numbers associated with one or more second parties (e.g., persons who may or may not have any bank accounts). The second party may be notified of the amount and the identification of the remitting party. The second party may spend any part of the received amount by transferring to another account (e.g., second party's account or a third party's account in the financial entity or other financial institutions or banks), receiving cash in an agent or shopping at a vendor's business.

An example method may include receiving a request, at a financial entity and from a first party, to remit an amount (e.g. $100) from an account, associated with the first party, at the financial entity to a mobile phone number associated with a second party; and notifying (e.g., by calling or sending a message such as a text message) the second party of the amount to be remitted and an identity (e.g., name and phone number) of the first party.

In an example embodiment, the first party may use other financial institutions or agents, having an established banking relationship with the financial entity, to make a deposit into a first party's account in the financial entity or in a mobile phone number associated with the first party. The first party may receive a message (e.g., phone call or message such as text message or email) from the financial entity or any of the other financial institutions or agents whereat the deposit was made, confirming receipt of a deposit amount in the first party's account in the financial entity. The first party may then request to remit from the account associated with the first party any portion of the deposit amount to the mobile phone number associated with the second party. According to example embodiments, the request by the first party may be made to the financial entity by a phone call or email to the financial entity or online via the Internet.

According to example embodiments, the method may include receiving a personal identification component from the second party such as a personal identification number (PIN); accessing a mobile account associated with the mobile phone number based on the personal identification component; and depositing the amount into the mobile account. The method may include creating a new mobile account associated with the mobile phone number and correlating the new mobile account with a personal identification component received from the second party at the time of a first instance of remittance to the mobile phone number.

In an example embodiment, the financial entity may receive other information related to the second party (e.g., personal information such as name, address, phone number, etc.) and open a new normal account associated with the second party at the financial entity.

Example embodiments may include, accessing the account associated with the first party at the financial entity responsive to receiving the request from the first party and transferring an initial amount equal to the amount from the account associated with the first party to the mobile account. The transferring may include one or approaches including a funds transfer from a mobile account or a stored value associated with the first party, a funds transfer from a bank account associated with the first party, or a charge against a credit card account associated with the first party. According to an example embodiment, an agent may receive a payment from the first party for deposit into the account associated with the first party.

Example embodiments may include receiving a request from the second party to transfer at least a portion of the amount, remitted to the mobile account associated with the second party, to a third party. The transfer to the third party may include a fund transfer to a mobile account associated with the third party, a fund transfer to a bank account associated with the third party, or a cash transfer via an agent to the third party. The financial entity may identify the second party by an identification component before allowing the second party to transfer any portion of the amount.

According to an example embodiment, transferring by the first party may include using near field communication (NFC). Using NFC may include using a radio frequency identification (RFID) card. The RFID card may be installed in a mobile phone or a RFID reader. Another example of NFC may include using a Bluetooth (an industrial specification for wireless personal area networks) chip in the mobile phone to communicate with any Bluetooth enabled system (e.g., an ATM or another mobile device).

In an example embodiment, the financial entity may receive from the second party, a request to identify an agent from which the amount to be redeemed. The financial entity may send a message to the second party, the message informing the second party of a location of a selected agent.

According to an example embodiment, the financial entity may determine a geographic location of the second party, and identify the selected agent based on the selected agent being geographically proximate to the second party. The geographic location of the second party may be determined using information received from a mobile phone of the second party. For example, in some embodiments, the mobile phone of the second party may provide GPS information to define the geographic location of the second party.

Example embodiments may include transfers which include, providing free mobile service by crediting a mobile account of the second party with a remittance of service credits by the financial entity for a promotional period. After the promotional period, the financial entity may charge a transaction fee to an account associated with the first party at the remittance initiation time, or deduct the transaction fee from the amount before remitting to the second party.

### Example System Architecture

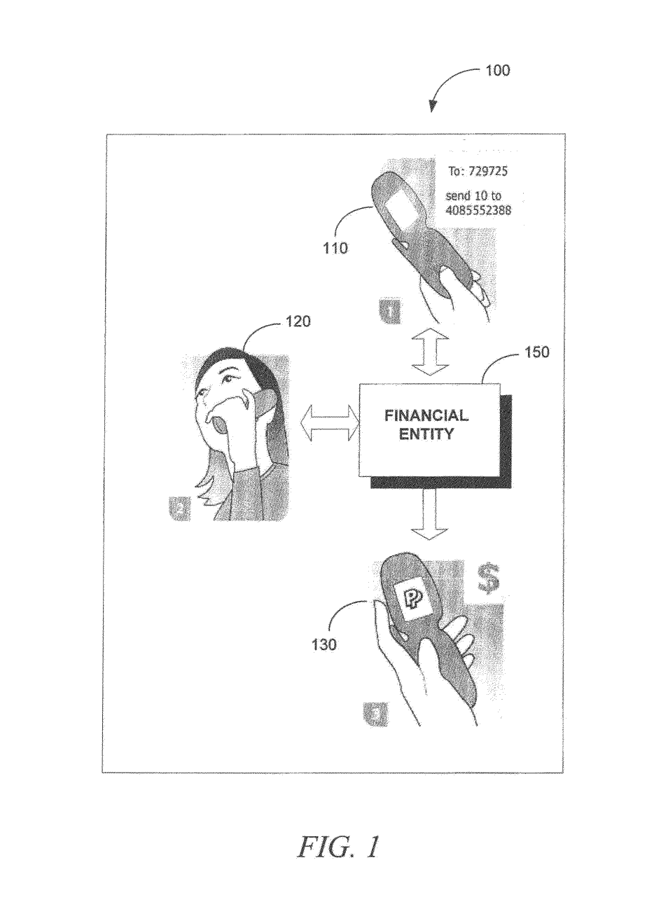

FIG. 1 is a high level diagram depicting an example embodiment of a method 100 for mobile remittances and/or payments. The method may involve a first party, a second party and a financial entity 150 (e.g., PayPal). At step 110 the first party may send a message (e.g., text message) to the financial entity 150 (e.g., to 729725) to send an amount (e.g. $10) to a mobile phone number (e.g., 408 5552388).

At step 120, a representative of the financial entity 150 may call the first party to confirm with the first party the first party's PIN. The representative may also request a confirmation of the amount and the mobile phone number of the second party. The representative may be an automated interactive voice (IVR) system. According to example embodiments an account associated with the first party (e.g., a stored value, a bank account, and a credit/debit account) may be debited or a gift certificate or other promotional value associated with the first party may be charged.

At step 130, the financial entity 150 may send a message (e.g., a text message) to the second party or call—the second party or send an email to the second party to notify the second party of the amount and the identity of the first party and, in case where the phone is not already activated for a mobile account in the financial entity 150 (e.g., PayPal mobile), to inform the second party of ways to spend the amount.

In an alternative example embodiment, the first party may visit a website associated with the financial entity 150 to login and complete a request form to initiate a remittance. After receiving the completed request form, the financial entity 150 may remit the amount to the second party and notify the second party of the remittance details (e.g., the amount, the identity of the first party, and inform the second party of ways to spend the amount, in case where the phone is not activated for a mobile account in the financial entity 150).

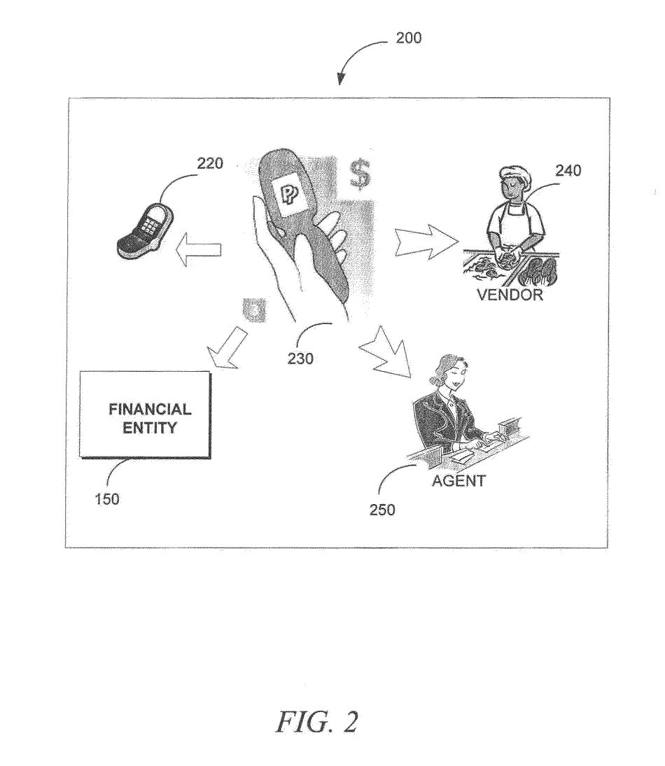

FIG. 2 is a high level diagram illustrating example embodiments of various spending channels 200 available to a mobile account holder. The second party 230, upon receipt of the amount from the financial entity 150 into his mobile account number, may spend any portion of the amount through various channels. The spending channels available to the second party may include transferring to another mobile phone number 220, transferring to the second party's account in the financial entity 150, transferring to a third party's account in the financial entity 150, or transferring to the second party's account at another financial entity (e.g. a local bank).

According to example embodiments, the second party 230 may spend any portion of the amount in his mobile account at an agent 250 by receiving cash at the agent 250 or transferring to an account in a financial institution (e.g. the financial entity 150, or any other financial institutions that may have established banking relation with the agent 250). Alternatively, the second party 230 may go to a vendor 240 to spend any portion of the amount in the mobile account number.

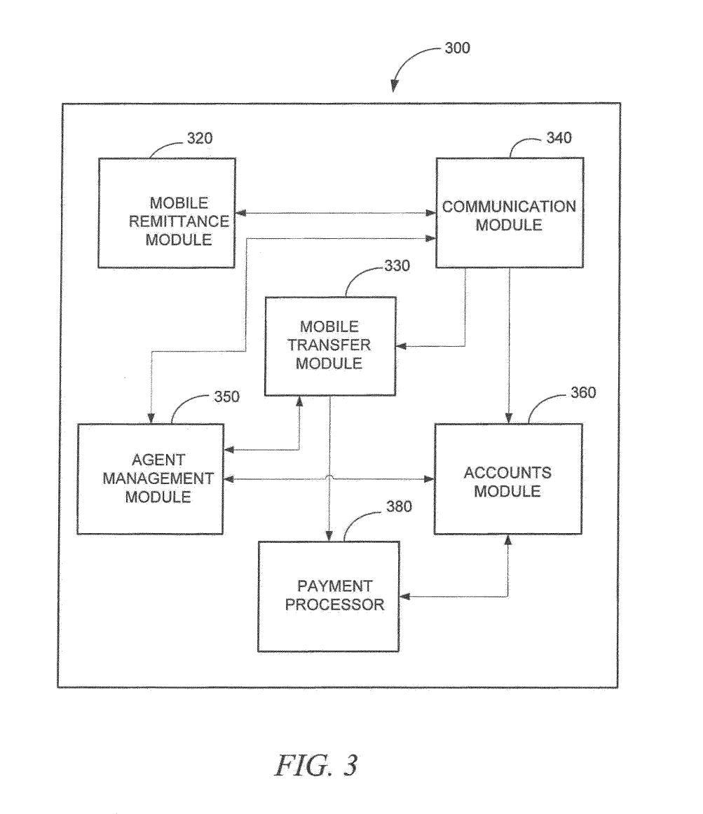

FIG. 3 is a block diagram illustrating an example embodiment of a system 300 for mobile remittances and/or payments. The mobile remittance system 300 may include a mobile remittance module 320, a communication module 340, a mobile transfer module 330, an agent management module 350, an accounts module 360 and a payment processor 380. The mobile remittance module 320 may receive, via the communication module 340, a request from the first party to remit an amount from an account associated with the first party, at the financial entity 150, to a mobile phone number associated with a second party.

In response, the mobile remittance module 320 may use the communication module 340 to notify the second party of the amount to be remitted and an identity of the first party. The communication module 340 may also receive a personal identification component from the second party and pass that to the accounts module 360. In an example embodiment, the communication module 340 may receive other information (e.g., personal information such as name, address, phone number, etc.) and pass it to the accounts module 360. The accounts module 360 may open a new account associated with the second party 230 at the financial entity 150. The account may be a normal account or a mobile account.

In case where it is the first instance of remittance to the mobile account number, the accounts module 360 may create a new account (e.g. mobile account) associated with the mobile phone number and may correlate the new account with the PIN. Otherwise, the accounts module 360 may access the mobile account associated with the mobile phone number based on the personal identification component and have the payment processor to deposit the amount into the mobile account

In an example embodiment, the mobile remittance module 320 may access an account associated with the first party at the financial entity, responsive to receiving the request from the first party, and transfer an initial amount less than or equal to the amount from the account associated with the first party to the mobile account associated with the second party 230. The case where the initial amount is less than the amount may be related to situations including charging a transaction fee by the financial entity and reducing the remitted amount by an amount of the transaction fee.

In an example embodiment, the mobile transfer module 330 may receive a request from the second party to transfer at least a portion of the amount to a third party. According to an example embodiment, the mobile transfer module 330 may identify the second party with an identification component (e.g., PIN) before allowing the second party to transfer any portion of the amount.

The agent management module 350 may receive a payment made by the first party, at an agent, for deposit into the account associated with the first party. According to an example embodiment, the agent management module 350 may receive from the first party a request to identify an agent. The agent management module 350 may send a message (e.g., text message or e-mail) from the financial entity to the first party informing the first party of a location of a selected agent.

In an example embodiment, the agent management module 350 may receive from the second party a request to identify an agent whereat the received amount may be redeemed. The agent management module 350 may send a message from the financial entity to the second party 230 informing the first party of a location of a selected agent.

The agent management module 350 may determine a geographical location of a requesting party (e.g., the first party or the second party 230), requesting identification of an agent, and identify the selected agent based on the selected agent being geographically proximate to the requesting party. The agent management module 350 may determine the geographic location of the requesting party by using information received from a mobile phone of the requesting party.

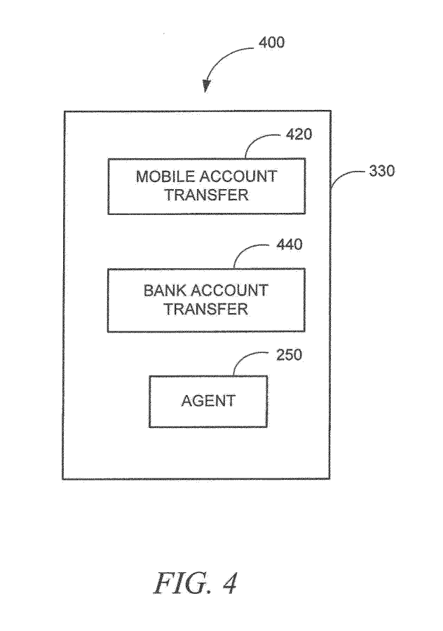

FIG. 4 is a block diagram depicting an example embodiment of a sub-module configuration of a mobile transfer module 330. The mobile transfer module 330 may include a mobile account transfer sub-module 420, a bank account transfer sub-module 440 and an agent 250. The mobile account transfer sub-module 420 may be used by the mobile transfer module 330 to transfer a fund from the mobile account associated with the second party to a mobile account associated with a third party.

According to an example embodiment, the bank account transfer sub-module 440 may be used by the mobile transfer module 330 to transfer a fund from the mobile account associated with the second party 230 to a bank account. The bank account may be associated with the second party 230 or the third party. In another example embodiment, the mobile transfer module 330 may use the agent 250 to perform a cash transfer to the third party.

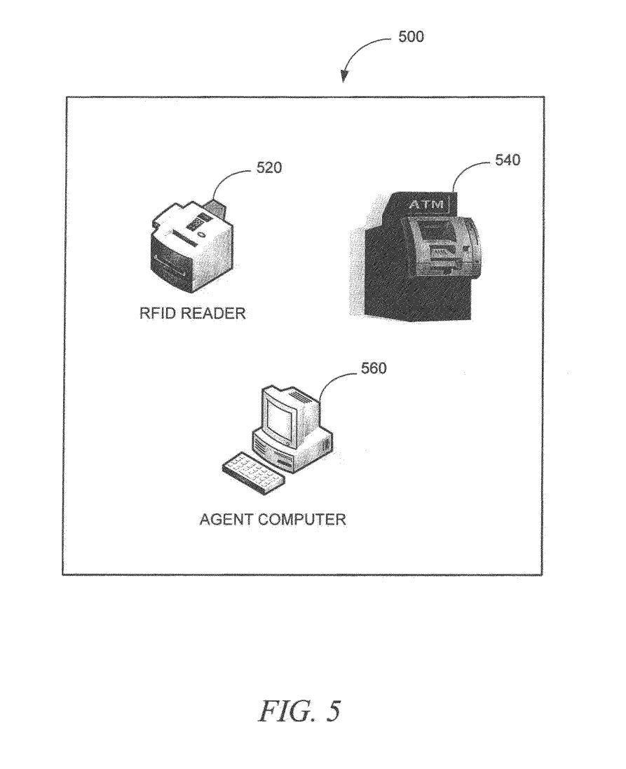

FIG. 5 is a diagram illustrating in an example embodiment of various components 500 of an agent site. At a site used by the agent 250, there may be an agent computer 560, an RFID reader 520, or an ATM machine 540. The agent computer 560 may be used by a human agent or a site attendee (e.g., the second party or the first party) to perform the required cash transfer to/from a mobile account number or an account number at any institution, financially linked to the agent 250 (e.g., the financial entity 150).

In an example embodiment, a mobile phone (e.g., the mobile phone associated with the first/second party) may include an RFID card. In that case, the mobile phone user (e.g., the first/second party) may use the RFID reader 520 to perform a fund transfer.

In another example embodiment, the mobile phone user may use the ATM machine 540 to perform a fund transfer from his/her mobile account number. According to an example embodiment, mobile phone user may use the RFID reader 520 to communicate, via his mobile phone, to the ATM machine 540 or the agent computer 560.

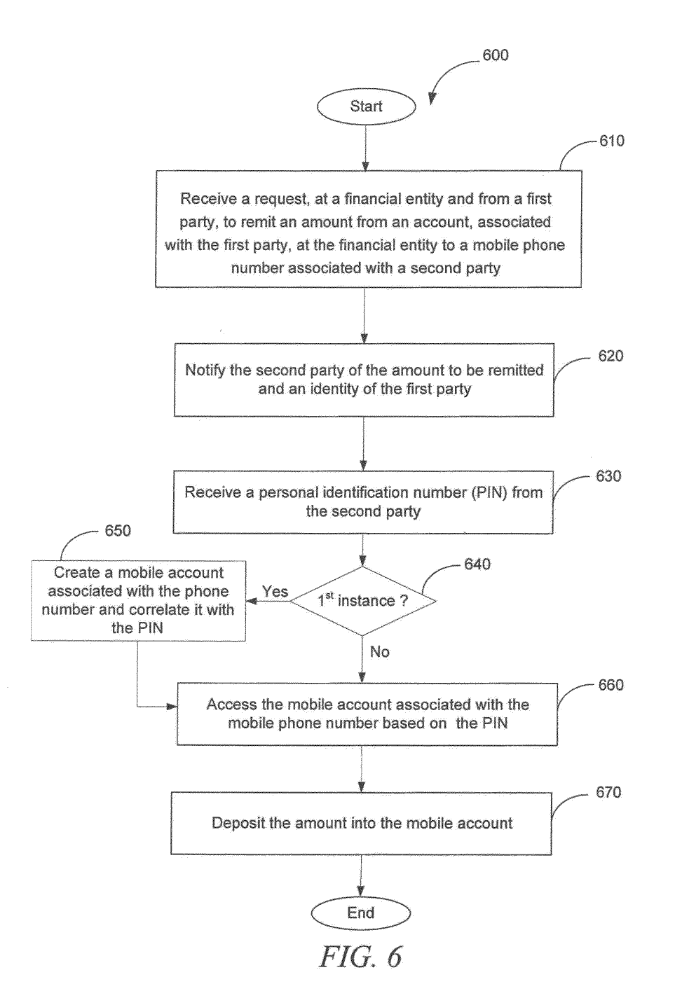

FIG. 6 is an example flow diagram illustrating an example embodiment of a method 600 for mobile remittances and/or payments. The method 600 starts at operation 610, where the mobile remittance module 320 may receive, via the communication module 340, a request from a first party to remit an amount from an account associated with the first party at the financial entity 150 to a mobile phone number associated with the second party 230.

At operation 620, the communication module 340 may notify (e.g., using text messaging, or email) the second party 230 of the amount to be remitted and an identity of the first party remitting the amount. Following the notification, at operation 630, the communication module 340 may request and receive, from the second party, a personal identification component and transfer it to the accounts module 360. In an example embodiment, the personal identification component may include remote identification mechanisms such as biometric identification. The biometric identification may be employed using a biometric reader installed in the second party's phone.

At operation 640, after examining the mobile phone number, the accounts module 360 will determine if it is the first instance of remittance to that mobile account number. In case where it is established that it is the first instance of remittance to the mobile account number, the accounts module 360, at operation 650, may create a mobile account associated with the phone number and correlate that account with the received PIN. Otherwise, where it is determined that the mobile account has already been created, at operation 660, the accounts module 360 may access the mobile account associated with the mobile phone number based on the received PIN.

At operation 670, the accounts module 360 may request the payment processor 380 to deposit the amount into the mobile account of the second party.

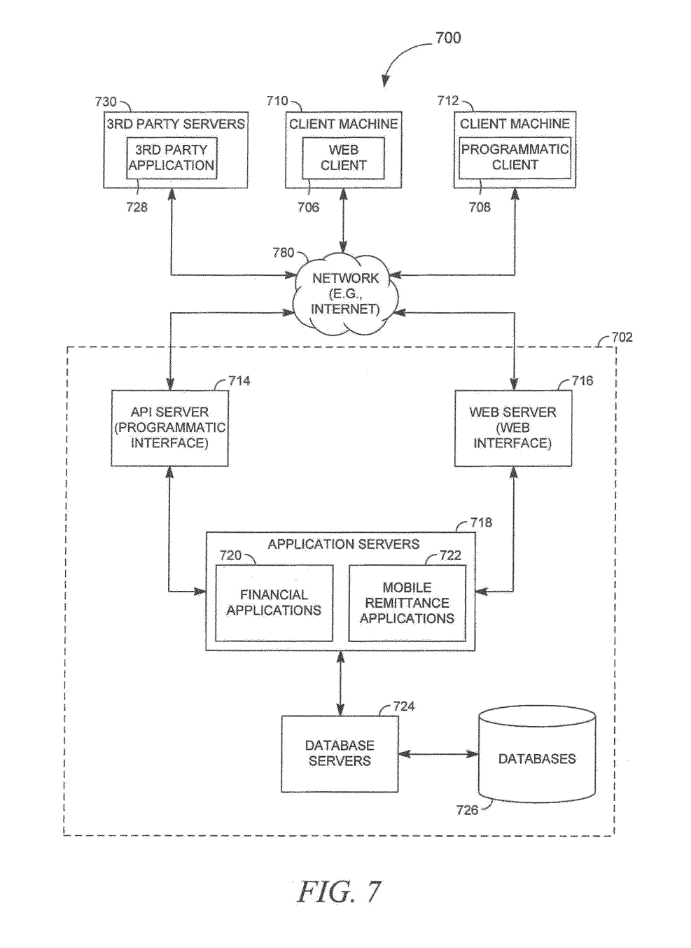

FIG. 7 is a high-level block diagram illustrating an example embodiment of a network-based mobile remittance system 700, having a client-server architecture used for mobile remittance and/or payments. A financial platform, in the example form of a network-based financial system 702, provides server-side functionality, via a network 780 (e.g., the Internet) to one or more clients. FIG. 7 illustrates, for example, a web client 706 (e.g., a browser, such as the Internet Explorer browser developed by Microsoft Corporation of Redmond, Wash.), and a programmatic client 708 executing on respective client machines 710 and 712. In an example embodiment, either or both of the web client 706 and programmatic client 708 may include a mobile device.

Turning specifically to the network-based financial system 702, an Application Program Interface (API) server 714 and a web server 716 are coupled to, and provide programmatic and web interfaces respectively to, one or more application servers 718. The application servers 718 host one or more financial applications 720 and mobile remittance applications 722. The application servers 718 are, in turn, shown to be coupled to one or more database servers 724 that facilitate access to one or more databases 726.

The financial applications 720 provide a number of financial functions and services to users that access the network-based financial system 702. The mobile remittance applications 722 facilitate mobile remittance and/or payments to mobile accounts associated with mobile phone numbers.

Further, while the system 700 shown in FIG. 7 employs a client-server architecture, the present application is of course not limited to such an architecture, and could equally well find application in a distributed, or peer-to-peer, architecture system. The various financial and mobile remittance applications 720 and 722 may also be implemented as standalone software programs, which do not necessarily have networking capabilities.

The web client 706, it will be appreciated, may access the various financial and mobile remittance applications 720 and 722 via the web interface supported by the web server 716. Similarly, the programmatic client 708 accesses the various services and functions provided by the financial and mobile remittance applications 720 and 722 via the programmatic interface provided by the API server 714. The programmatic client 708 may, for example, be a remittance application to enable a user to authorize transfer of money from one or more of his/her accounts to one or more mobile phone numbers and to perform batch-mode communications between the programmatic client 708 and the network-based financial system 702.

FIG. 7 also illustrates a third party application 728, executing on a third party server machine 730, as having programmatic access to the network-based financial system 702 via the programmatic interface provided by the API server 714. For example, the third party application 728 may, utilizing information retrieved from the network-based financial system 702, support one or more features or functions on a website hosted by the third party. The third party website may, for example, provide one or more remittance or payment functions that are supported by the relevant applications of the network-based financial system 702.

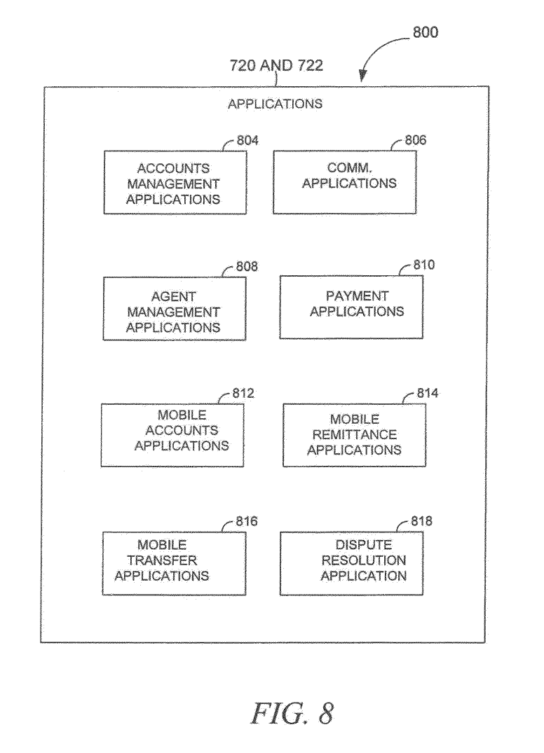

FIG. 8 is a diagram illustrating multiple example financial and mobile remittance applications 800 that, in one example embodiment, are provided as part of the network-based financial system 702. The network-based financial system 702 may provide a number of remittance and payment mechanisms whereby a user may request a remittance from one or more of his/her accounts to a one or more mobile phones.

The financial applications 720 are shown to include one or more account management applications 804 which support and provide services related to various user accounts in a financial entity (e.g. PayPal). The various account management applications 804 may also provide a number of features such as supervising account transfers, holding account balances, and keeping tracking of and reporting transactions to relevant applications.

A number of communication applications 806 may support communication between the network-based financial system 702 and users' mobile phones. For example, the user who may utilize their mobile phones to communicate with the network-based financial system 702 and place their request for remittance from their accounts to one or more mobile phone numbers. In another example embodiment, the communication applications 806 may also facilitate communicating with mobile phone numbers to notify the owners of the mobile phone numbers of remittances from other parties to their mobile phone numbers. The communication applications 806 may support may support any other communication between the network-based financial system 702 and the outside world.

Agent management applications 808 may provide services to and support activities of agents 250 transacting with users. Users of the agents 250 may be the individuals holding account at the network-based financial system 702 who may use the agents 250 to remotely transact with the network-based financial system 702. In an example embodiment, the users may be mobile phone account holders who may want to spend the money received into their mobile phone accounts or transfer that money to other accounts (e.g., their accounts at the network-based financial system 702 or accounts associated with third parties at the network-based financial system 702 or other financial institutions networked with the agent 250.)

Payment applications 810 may support mobile remittance applications 814 to provide service to users requesting remittances form their accounts in the network-based financial system 702 to one or more mobile phone numbers associated with third parties. In other example embodiments, the payment applications may support to mobile transfer applications 816 to provide services to mobile phone account holders, in order to transfer money from their mobile phone accounts to other parties or their accounts in the network-based financial system 702.

As part of the mobile remittance applications 722, mobile accounts applications 812 may keep a list of all mobile phone accounts and respond to various requests, related to mobile phone accounts, made by the mobile remittance applications 814 and the mobile transfer applications 816.

The mobile remittance applications 814 may provide mechanisms whereby a user may remit money from his/her account in the network-based financial system 702 or any other financial institutions linked with the network-based financial system 702 to a mobile phone number associated with another party. In another example embodiment, the mobile remittance applications 814 may also support agents 250, via the agent management applications 808, to provide users with services to remit money from their accounts in the network-based financial system 702 or any other financial institutions linked with the network-based financial system 702 to a mobile phone number associated with another party.

The mobile transfer applications 816 may provide services to mobile phone account holders to spend money remitted to their accounts, by the mobile remittance applications 814, through transferring parts of the remitted money to one or more accounts associated with third parties in the network-based financial system 702 or any other financial institutions linked with the network-based financial system 702.

Dispute resolution applications 818 may provide mechanisms whereby disputes arising between transacting parties may be resolved. For example, the dispute resolution applications 818 may provide guided procedures whereby the parties are guided through a number of steps in an attempt to settle a dispute. In the event that the dispute cannot be settled via the guided procedures, the dispute may be escalated to a customer service agent for the financial system, third party mediator, or arbitrator.

### Machine Architecture

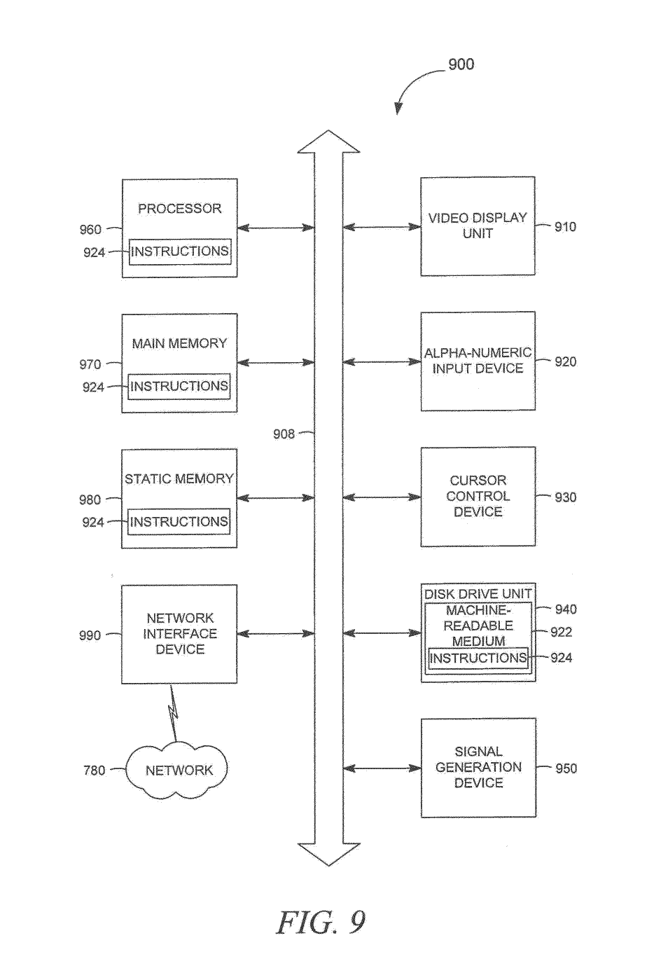

FIG. 9 is a block diagram, illustrating a diagrammatic representation of machine 900 in the example form of a computer system within which a set of instructions for causing the machine to perform any one or more of the methodologies discussed herein may be executed. In alternative embodiments, the machine 900 may operate as a standalone device or may be connected (e.g., networked) to other machines. In a networked deployment, the machine 900 may operate in the capacity of a server or a client machine in a server-client network environment, or as a peer machine in a peer-to-peer (or distributed) network environment.

The machine 900 may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 may include a processor 960 (e.g., a central processing unit (CPU), a graphics processing unit (GPU) or both), a main memory 970 and a static memory 980, all of which communicate with each other via a bus 908. The computer system 900 may further include a video display unit 910 (e.g., liquid crystal displays (LCD) or cathode ray tube (CRT)). The computer system 900 also may include an alphanumeric input device 920 (e.g., a keyboard), a cursor control device 930 (e.g., a mouse), a disk drive unit 940, a signal generation device 950 (e.g., a speaker) and a network interface device 990.

The disk drive unit 940 may include a machine-readable medium 922 on which is stored one or more sets of instructions (e.g., software 924) embodying any one or more of the methodologies or functions described herein. The software 924 may also reside, completely or at least partially, within the main memory 970 and/or within the processor 960 during execution thereof by the computer system 900, the main memory 970 and the processor 960 also constituting machine-readable media.

The software 924 may further be transmitted or received over a network 780 via the network interface device 990.

While the machine-readable medium 922 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories and optical and magnetic media.

Thus, a method and a system for mobile remittance and/or payments have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. (canceled)

2. A system comprising:
one or more computer processors and computer storage age configured to;
receive, via a network interface device, a request from a first party to a financial entity to transfer a remittance from an account of the first party to a mobile account associated with a mobile phone number of a mobile phone of a second party;
notify the second party of the amount of the remittance and an identity of the first party, and receive a personal identification component from the second party;
receive, from the second party via the network interface device, a request to identify an agent from which the amount is to be redeemed, and send a message from the financial entity to the second party to identify a location of the agent based on geographic information from the mobile phone; and
create a new mobile account associated with the mobile phone number and correlate the new mobile account with the personal identification component, at a first instance of remittance to the mobile phone number.

3. The system of claim 2, the computer processor and storage further configured to notify the second party by calling the mobile phone number associated with the second party receiving the amount.

4. The system of claim 2, the computer processor and storage further configured to access the account associated with the first party at the financial entity responsive to receiving the request and to transfer an initial amount less than or equal to the amount from the account associated with the first party to the mobile account.

5. The system of claim 2, the computer processor and storage further configured to identify the second party by an identification component before allowing the second party to transfer any portion of the amount.

6. The system of claim 2, the computer processor and storage further configured to transfer a fund to a mobile account associated with the third party, transfer a fund to a bank account associated with the third party, and perform a cash transfer to the third party.

7. The system of claim 6, the computer processor and storage further configured to use near field communication (NFC), including a radio frequency identification (RFID) card installed in a mobile phone and a RFID reader.

8. The system of claim 2, the computer processor and storage further configured to receive a payment made at the agent by the first party for deposit into the account associated with the first party.

9. A method comprising:
receiving, via a network interface device, a request from a first party to a financial entity to transfer a remittance from an account of the first party to a mobile account associated with a mobile phone number of a mobile phone of a second party;
notifying the second party of the amount of the remittance and an identity of the first party, and receiving a personal identification component from the second party;
receiving, from the second party via the network interface device, a request to identify an agent from which the amount is to be redeemed, and to send a message from the financial entity to the second party to identify a location of the agent based on geographic information from the mobile phone; and
creating a new mobile account associated with the mobile phone number if the remittance is the first instance of a remittance to the mobile phone number, and to access the new mobile account to have a payment processor deposit the amount into the new mobile account.

10. The method of claim 9, the notifying comprising calling the mobile phone number associated with the second party.

11. The method of claim 9, including accessing the account associated with the first party at the financial entity responsive to receiving the request and transferring an initial amount less than or equal to the amount from the account associated with the first party to the mobile account.

12. The method of claim 11, wherein the transferring includes at least one of:
a fund transfer from a mobile account associated with the first party,
a fund transfer from a bank account associated with the first party, and
a charge against a credit card account associated with the first party.

13. The method of claim 9, including receiving by the agent of a payment from the first party for deposit into the account associated with the first party.

14. The method of claim 9 including receiving a request from the second party to transfer at least a portion of the amount to a third party, the transfer to the third party including at least one of:
a fund transfer to a mobile account associated with the third party,
a fund transfer to a bank account associated with the third party, and
a cash transfer via the agent to the third party.

15. The method of claim 14, including identifying the second party by a personal identification component before allowing the second party to transfer any portion of the amount.

16. The method of claim 9, the personal identification component including at least one of a personal identification number (PIN) or a biometric identification signature.

17. A computer-readable hardware storage device having embedded therein a set of instructions which, when executed by one or more processors of a computer, causes the one or more processors of the computer to execute the following operations:
receiving, via a network interface device, a request from a first party to a financial entity to transfer a remittance from an account of the first party to a mobile account associated with a mobile phone number of a mobile phone of a second party;
notifying the second party of the amount of the remittance and an identity of the first party, and receiving a personal identification component from the second party;
receiving, from the second party via the network interface device, a request to identify an agent from which the amount is to be redeemed, and sending a message from the financial entity to the second party to identify a location of the agent based on geographic information from the mobile phone; and
creating a new mobile account associated with the mobile phone number and correlating the new mobile account with the personal identification component, at a first instance of remittance to the mobile phone number.

18. The computer-readable hardware storage device of claim 17 the notifying including calling the mobile phone number associated with the second party.

19. The computer-readable hardware storage device of claim 17, including accessing the account associated with the first party at the financial entity responsive to receiving the request and transferring an amount less than or equal to the amount from the account associated with the first party to the mobile account.

20. The computer-readable hardware storage device of claim 19, wherein the transferring includes at least one of:
a fund transfer from a mobile account associated with the first party,
a fund transfer from a bank account associated with the first party, and
a charge against a credit card account associated with the first party.

21. The computer-readable hardware storage device of claim 17, including receiving by the agent a payment from the first party for deposit into the account associated with the first party.

22. The computer-readable hardware storage device of claim 17, including receiving a request from the second party to transfer at least a portion of the amount to a third party, the transfer to the third party including at least one of:
a fund transfer to a mobile account associated with the third party,
a fund transfer to a bank account associated with the third party, and
a cash transfer via the agent to the third party.

23. The computer-readable hardware storage device of claim 17, including identifying the second party by a personal identification component before allowing the second party to transfer any portion of the amount.

24. The computer-readable hardware storage device of claim 17, the personal identification component including at least one of a personal identification number (PIN) or a biometric identification signature.
